(19) United States
(12) Patent Application Publication
(10) Pub. No.: US 2026/0167465 A1
(43) Pub. Date: Jun. 18, 2026

(54) CRANE

(71) Applicant: KOBELCO CONSTRUCTION MACHINERY CO., LTD., Hiroshima-shi (JP)

(72) Inventors: Akira KOYAHATA, Hyogo (JP); Dairo MATSUI, Hyogo (JP)

(73) Assignee: KOBELCO CONSTRUCTION MACHINERY CO., LTD., Hiroshima-shi (JP)

(21) Appl. No.: 18/716,798

(22) PCT Filed: Oct. 28, 2022
(86) PCT No.: PCT/JP2022/040307

§ 371 Date: Jun. 5, 2024

(30) Foreign Application Priority Data
Dec. 8, 2021 (JP) 2021-199132
Feb. 18, 2022 (JP) 2022-023588

(51) Int. Cl. B66C 23/76; B66C 23/36; B66C 23/44

(52) U.S. Cl. CPC B66C 23/76; B66C 23/36; B66C 23/365; B66C 23/44

(57) ABSTRACT

A crane includes: a crane body; an undulating body including an undulating body fulcrum supported on the crane body to be rotatable in an undulation direction about a horizontal rotation center axis; a backstop that is expandable, has a first end portion and a second end portion, is interposed between the undulating body and the upper slewing body in a state where the undulating body rises from the upper slewing body, and supports the undulating body from behind; and an assistance structure configured to assist the backstop in supporting the undulating body.

### TECHNICAL FIELD

The present invention relates to a crane.

### BACKGROUND ART

There has been conventionally known a crane including a crane body and a boom. The boom is supported on the crane body so as to be undulated about a horizontal rotation axis. Patent Literature 1 discloses a crane further including a pair of left and right backstops interposed between the boom and the crane body in order to prevent the boom from falling backward. The crane body has a center portion in the front-back direction provided with a receiving member configured to receive each of the backstops.

Each of the backstops according to this technique includes an outer cylinder, an inner cylinder inserted to the outer cylinder, and a contractive spring member interposed between the outer cylinder and the inner cylinder. The spring member expands and contracts to vary a length of the backstop. The backstop has a proximal end portion supported on the boom. When the boom rises from the crane body, a distal end portion of the backstop eventually comes into contact with the receiving member provided on the crane body and the spring member contracts. The spring member has a contracting energy having a function of pushing back the boom in an inverted direction during disassembly of the crane. When the boom is flapped backward by strong wind or the like during operation of the crane, the spring member of the backstop contracts to a minimum size to cause the backstop to have a minimum length, and the backstop supports the boom from behind to prevent the boom from falling (flapping) backward.

### CITATION LIST

### Patent Literature

Patent Literature 1: JP 2012-232822 A

In recent years, an undulating body tends to be increased in wind receiving area for wind reception due to increase in length of the undulating body such as the boom, increase of attachments to the undulating body, and the like. In this case, among forces required to the backstop, force of supporting the undulating body from behind to prevent flapping of the undulating body during normal operation tends to be larger than force of pushing back the undulating body in a lay-down direction during disassembly of the crane. The conventional technique described in Patent Literature 1 or the like thus has a problem of increase in strength required to the spring member of the backstop and increase in cost therefor.

### SUMMARY OF INVENTION

It is an object of the present invention to provide a crane configured to stably prevent an undulating body from falling due to strong wind or the like during normal operation without increase in strength or cost of a member supporting the undulating body.

The present invention provides a crane including: a crane body; an undulating body including an undulating body fulcrum supported on the crane body to be rotatable in an undulation direction about a rotation center axis extending horizontally; a backstop being expandable, having a first end portion and a second end portion, and interposed between the undulating body and the crane body in a state where the undulating body rises from the crane body to support the undulating body from behind; and an assistance structure configured to assist the backstop in supporting the undulating body.

### BRIEF DESCRIPTION OF DRAWINGS

FIG. 1 is a side view of a crane according to a first embodiment of the present invention.

FIG. 2 is a side view of a lower boom, a boom support, and a boom stop in a state where a boom of the crane according to the first embodiment of the present invention is in a laid-down posture.

FIG. 3 is a side view of an undulating body and a crane body of the crane according to the first embodiment of the present invention.

FIG. 4 is a back view of a boom support receiving portion of the crane according to the first embodiment of the present invention.

FIG. 5 is a side view of an undulating body and a crane body of a crane according to a variation example of the first embodiment of the present invention.

FIG. 6 is a side view of a crane according to a second embodiment of the present invention.

FIG. 7 is a side view of a lower boom and a backstop in a state where a boom of the crane according to the second embodiment of the present invention is in a laid-down posture.

FIG. 8 is an enlarged side view of part of an upper slewing body of the crane according to the second embodiment of the present invention.

FIG. 9 is an enlarged perspective view of the part of the upper slewing body of the crane according to the second embodiment of the present invention.

FIG. 10 is a plan view of a slewing frame of the upper slewing body of the crane according to the second embodiment of the present invention.

FIG. 11 is a side view of a conventional crane to be compared with the crane according to the second embodiment of the present invention.

FIG. 12 is a side view of a lower boom and a backstop in a state where a boom of the conventional crane is in a laid-down posture.

FIG. 13 is a side view of the lower boom and the backstop when the backstop of the conventional crane comes into a rising state from the state where the boom is in the laid-down posture.

FIG. 14 is a side view of the lower boom, an upper slewing body, and the backstop in the state where the boom of the conventional crane is in a rising posture.

### DESCRIPTION OF EMBODIMENTS

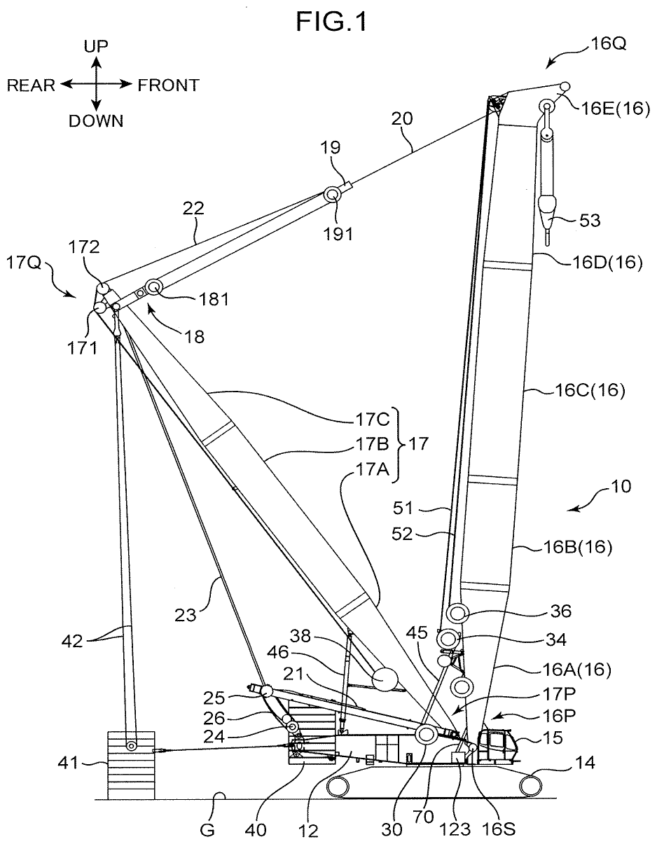

Embodiments of the present invention will be hereinafter described with reference to the drawings. FIG. 1 is a side view of a crane 10 (working machine) according to a first embodiment of the present invention. Hereinafter, each drawing includes indication of directions of “up”, “down”, “front”, and “rear”. These directions are indicated for convenience in description of a structure and an assembling method of the crane 10 according to the present embodiment, and do not limit any shifting direction, any use mode, or the like of the crane according to the present invention.

The crane 10 includes an upper slewing body 12 and a lower travelling body 14 that correspond to a crane body, a cab 15 provided on the upper slewing body 12, a boom 16 functioning as an undulating body, a lattice mast 17 as a boom undulation member, and a box mast 21. The lower travelling body 14 is configured to travel on the ground (on a travelling surface), and the upper slewing body 12 is supported on the lower travelling body 14 so as to be slewable about a slew center axis extending in an up-down direction.

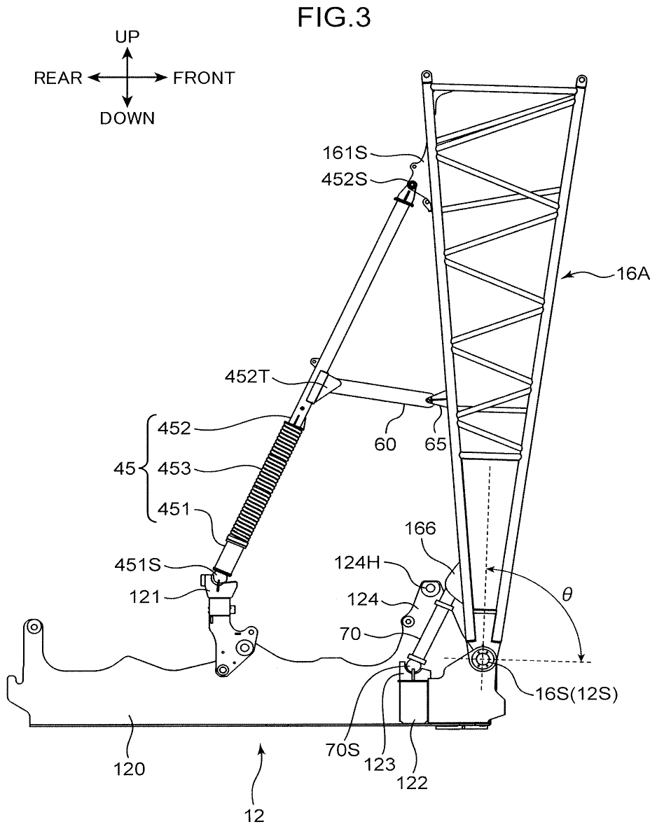

The boom 16 includes a boom proximal end portion 16P (undulating body proximal end portion) supported on the upper slewing body 12 so as to be rotatable in an undulation direction, and a boom distal end portion 16Q (undulating body distal end portion) disposed opposite to the boom proximal end portion 16P in a longitudinal direction. The boom proximal end portion 16P according to the present embodiment includes a boom foot 16S (undulating body fulcrum) that is supported to be rotatable in the undulation direction on a boom foot backing portion 12S (FIG. 3) to be described later of the upper slewing body 12. The boom 16 depicted in FIG. 1 is of a so-called lattice type, and can be divided into a plurality of members. Specifically, the boom 16 includes a lower boom 16A (undulating body lower member) including the boom foot 16S, a single or a plurality of (three exemplarily depicted) intermediate booms 16B, 16C, and 16D, and an upper boom 16E.

The lattice mast 17 includes a mast proximal end portion 17P and a mast distal end portion 17Q. The mast proximal end portion 17P is mounted to the upper slewing body 12 so as to be undulated about a rotation axis parallel to a rotation axis of the boom 16 at a position behind the boom 16. That is, the lattice mast 17 is also rotatable in a direction identical to the undulation direction of the boom 16. The mast distal end portion 17Q corresponds to a distal end portion of the lattice mast 17 disposed opposite to the mast proximal end portion 17P in the longitudinal direction. As depicted in FIG. 1, the mast distal end portion 17Q of the lattice mast 17 is provided with a first mast sheave 171 and a second mast sheave 172. The first mast sheave 171 and the second mast sheave 172 are rounded by a boom undulation rope 22 to be described later. The lattice mast 17 serves as a pillar for rotation of the boom 16.

The lattice mast 17 is provided, adjacent to the mast proximal end portion 17P, with a pair of left and right backstops 46. Each of these backstops 46 comes into contact with the upper slewing body 12 when the lattice mast 17 comes into a rising posture as depicted in FIG. 1. This contact restrains the lattice mast 17 from being flapped backward by strong wind or the like.

The crane 10 further includes a lower spreader 18, an upper spreader 19, a guyline 20, the boom undulation rope 22, and a boom undulation winch 38.

The lower spreader 18 includes a lower sheave block 181. The lower sheave block 181 is provided with a plurality of sheaves arrayed in a width direction (left-right direction). The upper spreader 19 is disposed ahead of the lower spreader 18 with a predetermined interval. The upper spreader 19 is connected to the boom distal end portion 16Q via the guyline 20. The upper spreader 19 includes an upper sheave block 191. The upper sheave block 191 is provided with a plurality of sheaves arrayed in the width direction (left-right direction).

There is provided a pair of guylines 20 disposed in the left-right direction perpendicular to a sheet of FIG. 1. Each of the guylines 20 has a rear end portion connected to the upper spreader 19, and a front end portion detachably connected to the boom distal end portion 16Q. The guyline 20 includes a guy link (metal board), a guy rope, a guy wire (metal wire rod), and the like.

The boom undulation rope 22 is led out of the boom undulation winch 38, is hung around the first mast sheave 171 and the second mast sheave 172 of the mast distal end portion 17Q, and is then wound a plurality of times between the lower sheave block 181 and the upper sheave block 191. The boom undulation rope 22 having been wound between the lower sheave block 181 and the upper sheave block 191 has a distal end portion fixed to the mast distal end portion 17Q of the lattice mast 17.

The boom undulation winch 38 is disposed adjacent to the mast proximal end portion 17P of the lattice mast 17. The boom undulation winch 38 winds up and releases the boom undulation rope 22 to vary a distance between the lower sheave block 181 of the lower spreader 18 and the upper sheave block 191 of the upper spreader 19, and rotates the boom 16 relatively to the lattice mast 17 to undulate the boom 16.

The box mast 21 has a proximal end and a rotation end (distal end), is disposed behind the lattice mast 17, and is rotatably coupled to the upper slewing body 12. The box mast 21 has a rectangular shape in a sectional view. The box mast 21 has a rotation axis parallel to the rotation axis of the boom 16 and positioned substantially identically with a rotation axis of the lattice mast 17. That is, the box mast 21 is also rotatable in a direction identical to the undulation direction of the boom 16.

The crane 10 further includes a guyline 23, a mast undulation rope 26, and a mast undulation winch 30. There is provided a pair of guylines 23 disposed in the left-right direction perpendicular to the sheet of FIG. 1. Each of the guylines 23 connects the mast distal end portion 17Q of the lattice mast 17 and a rotation end portion of the box mast 21. This connection causes cooperation between rotation of the lattice mast 17 and the box mast 21. The mast undulation rope 26 is wound a plurality of times between a sheave block 24 disposed on the upper slewing body 12 and including a plurality of sheaves arrayed in the width direction and a sheave block 25 disposed in the rotation end portion of the box mast 21 and including a plurality of sheaves arrayed in the width direction.

The mast undulation winch 30 is disposed adjacent to a proximal end portion of the box mast 21. The mast undulation winch 30 is configured to wind up and release the mast undulation rope 26. When the mast undulation winch 30 winds up or releases the rope, a distance is varied between the sheave block 25 in a distal end portion of the box mast 21 and the sheave block 24 in a rear end portion of the upper slewing body 12, and the lattice mast 17 is undulated while the box mast 21 and the lattice mast 17 are integrally rotating with respect to the upper slewing body 12.

In addition to the mast undulation winch 30 and the boom undulation winch 38 described above, the crane 10 is equipped with a main hoist winch 34 and an auxiliary hoist winch 36 for hoisting and lowering a load. In the crane 10 according to the present embodiment, both the main hoist winch 34 and the auxiliary hoist winch 36 are installed on the lower boom 16A of the boom 16. The winches 34 and 36 of the crane 10 may alternatively be equipped on the upper slewing body 12.

The main hoist winch 34 is configured to hoist and lower a load with use of a main hoist rope 51 (FIG. 1). As to this main hoisting, the boom distal end portion 16Q of the boom 16 is rotatably provided with a main hoist guide sheave (not depicted), and a main hoist sheave block is provided adjacent to the main hoist guide sheave and includes a plurality of main hoist point sheaves arrayed in the width direction. The main hoist rope 51 is suspended from the main hoist sheave block and is coupled to a main hook 53 for a load. The main hoist rope 51 led out of the main hoist winch 34 is consecutively hung around the main hoist guide sheave and is also hung between the sheaves of the main hoist sheave block and sheaves of a sheave block provided to the main hook 53. The main hook 53 is thus hoisted and lowered when the main hoist winch 34 winds up and releases the main hoist rope 51.

Similarly, the auxiliary hoist winch 36 is configured to hoist and lower a load with use of an auxiliary hoist rope 52. As to this auxiliary hoisting, there is provided a structure (not depicted) similar to a structure for the main hoisting described above. When the auxiliary hoist winch 36 winds up and releases the auxiliary hoist rope 52, an auxiliary hook (not depicted) for a load coupled to a terminal end of the auxiliary hoist rope 52 is hoisted or lowered.

The upper slewing body 12 has a rear portion loaded with a counter weight 40 for balance adjustment of the crane 10. The upper slewing body 12 is further provided therebehind with a pallet weight 41. The pallet weight 41 has a function of balancing the crane 10 as a super heavy lifting (SHL) weight provided to allow the crane 10 to lift a heavy object. The pallet weight 41 is connected to the mast distal end portion 17Q of the lattice mast 17 by means of a weight line 42.

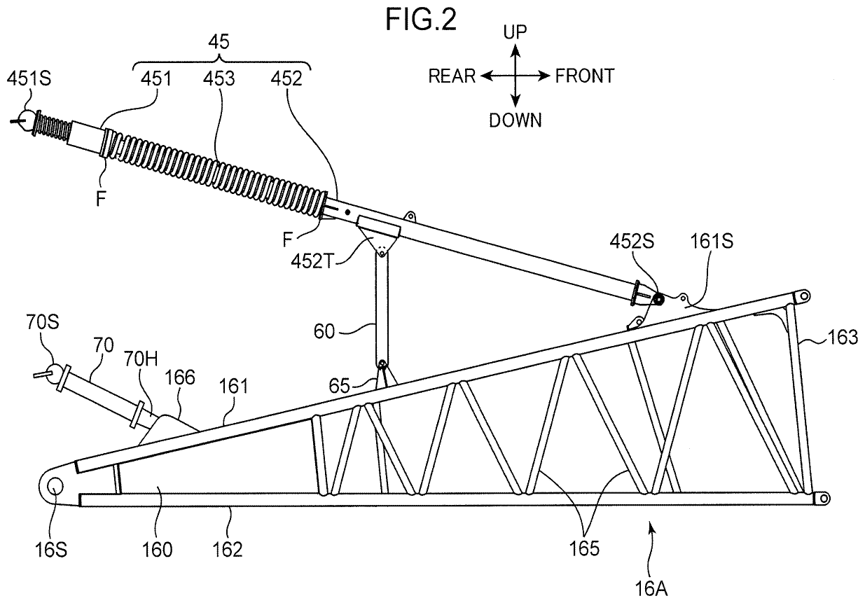

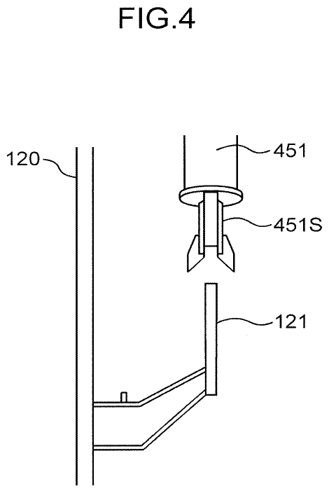

FIG. 2 is a side view of the lower boom 16A, a boom support 45, and a boom stop 70 in a state where the boom 16 of the crane 10 according to the present embodiment is in a laid-down posture. FIG. 3 is a side view of the lower boom 16A (the boom 16) and the upper slewing body 12 of the crane 10 according to the present embodiment. FIG. 4 is a back view of a boom support receiving portion 121 of the crane 10 according to the present embodiment.

With reference to FIG. 2, when viewed in a state where the boom 16 (lower boom 16A) is laid down with respect to the upper slewing body 12, the lower boom 16A includes a pair of left and right lower frames 160, a pair of left and right first main pipes 161, a pair of left and right second main pipes 162, a pair of left and right first connecting pipes 163, a pair of upper and lower second connecting pipes (not depicted), and a plurality of lattice pipes 165.

The pair of left and right first main pipes 161 and the pair of left and right second main pipes 162 define an outer shape of the lower boom 16A, and extend to increase an interval therebetween from adjacent to the boom foot 16S toward a distal end of the lower boom 16A as depicted in FIG. 2 and the like. The lower frames 160 are plate-shaped members coupling proximal end portions of the first main pipes 161 and the second main pipes 162 on left and right sides of the lower boom 16A. The pair of left and right first connecting pipes 163 connects distal end portions of the first main pipes 161 and the second main pipes 162. The pair of upper and lower second connecting pipes (not depicted) connects the distal end portions of the pair of left and right first main pipes 161 as well as the distal end portions of the pair of left and right second main pipes 162. The plurality of lattice pipes 165 connects the first main pipes 161 and the second main pipes 162, the pair of left and right first main pipes 161, and the pair of left and right second main pipes 162 at a plurality of points.

The lower boom 16A further includes a pair of left and right boom support backing portions 161S. The pair of left and right boom support backing portions 161S is disposed on the first main pipes 161 (a back surface of the lower boom 16A) at positions closer to the distal end than the boom foot 16S, more specifically, closer to the distal end than a longitudinal center portion of the lower boom 16A. The boom support backing portions 161S support boom support proximal end portions 452S of boom supports 45 to be described below.

The crane 10 further includes a pair of left and right boom supports 45 (support members or backstops), and a pair of left and right boom stops 70 (restraining members). As these left and right members are structured identically, the following description refers to the right members in terms of its structure. The pair of left and right boom stops 70 constitutes an assistance structure according to the present invention. The assistance structure assists the pair of left and right boom supports 45 in supporting the boom 16.

Each of the boom supports 45 provided on the lower boom 16A. The boom support 45 comes into contact with the upper slewing body 12 when the boom 16 reaches the rising posture (a working posture) depicted in FIG. 1 with respect to the upper slewing body 12, to be interposed between the boom 16 and the upper slewing body 12 and support the boom 16 from behind. The boom support 45 is expandable and has a function of pushing back the boom 16 forward, that is, in an inverted direction during disassembly of the crane 10.

As depicted in FIG. 2, the boom support 45 is disposed on the first main pipe 161. The boom support 45 includes a boom support lower portion 451 (also referred to as an inner cylinder), a boom support upper portion 452 (also referred to as an outer cylinder), and a boom support spring 453 (a spring member). The boom support lower portion 451 and the boom support upper portion 452 each have a cylinder structure, and the boom support lower portion 451 is expandably inserted to a cylindrical inner space of the boom support upper portion 452. The boom support spring 453 is contractively mounted between flanges F (FIG. 2) provided respectively on the boom support lower portion 451 and the boom support upper portion 452. The boom support spring 453 is disposed to be interposed between the boom support lower portion 451 and the boom support upper portion 452, and is configured to be contracted between a predetermined maximum spring length (a free length) and a minimum spring length. The boom support 45 has a maximum length when the boom support spring 453 has the maximum spring length, and the boom support 45 has a minimum length when the boom support spring 453 has the minimum spring length.

The boom support lower portion 451 further includes a boom support contact portion 451S, and the boom support upper portion 452 includes the boom support proximal end portion 452S. The boom support proximal end portion 452S corresponds to a proximal end portion of the boom support 45, and the boom support contact portion 451S corresponds to a distal end portion of the boom support 45 opposite to the boom support proximal end portion 452S. The boom support contact portion 451S is provided with a two-way projection (FIG. 4). The boom support proximal end portion 452S is rotatably supported by (mounted to) the boom support backing portion 161S (FIG. 2) disposed in a portion closer to a distal end portion (the boom distal end portion 16Q) of the lower boom 16A than the boom foot 16S.

The crane 10 further includes a pillar 60. The pillar 60 is coupled, by means of a coupling pin (not depicted), to each of a fixed portion 65 disposed on the first main pipe 161 and a supported portion 452T disposed on the boom support upper portion 452. The boom support 45 thus comes into a rising posture as depicted in FIG. 2. When the pillar 60 is detached during disassembly or the like of the crane 10, the boom support 45 can be laid down to a position closer to the first main pipe 161 than a position depicted in FIG. 2, specifically, a position just above the boom stop 70.

The boom support 45 described above is interposed between the boom 16 and the upper slewing body 12 when the boom 16 is in a rising state of rising from the upper slewing body 12 and the boom support spring 453 is contracted, and supports the boom 16 from behind while applying forward bias force to the boom 16.

The boom stop 70 is interposed between the upper slewing body 12 and the boom 16 when the boom 16 is in the rising state and the boom support spring 453 of the boom support 45 is contracted to a predetermined length between the maximum spring length and the minimum spring length (the boom support 45 has a predetermined restrained length between the maximum length and the minimum length), and receives a load (self weight) of the boom 16 to restrain the boom 16 from falling backward.

Similarly to the boom support 45, the boom stop 70 is disposed on the first main pipe 161. Specifically, the first main pipe 161 is provided with a boom stop backing portion 166 adjacent to the boom foot 16S. The boom stop 70 extends (projects) from the boom stop backing portion 166 in a substantially same direction as the boom support 45 in the rising posture. The boom stop 70 includes a boom stop contact portion 70S and a boom stop proximal end portion 70H. The boom stop contact portion 70S corresponds to a distal end portion of the boom stop 70. Similarly to the boom support contact portion 451S, the boom stop contact portion 70S is provided with a two-way projection. The boom stop proximal end portion 70H corresponds to a proximal end portion of the boom stop 70 opposite to the boom stop contact portion 70S and is fixed to the boom stop backing portion 166.

With reference to FIG. 3, the upper slewing body 12 includes a slewing frame 120. The slewing frame 120 is supported to be slewable on the lower travelling body 14. The slewing frame 120 is a member extending in the front-back direction and the left-right direction, and is exemplarily constituted by a frame of joint steel members.

The upper slewing body 12 further includes a pair of left and right boom foot backing portions 12S, a pair of left and right boom support receiving portions 121, a pair of left and right base bodies 122 having a box shape, a pair of left and right boom stop receiving portions 123 (restraining member receiving portions), and a pair of left and right mast backing portions 124.

The pair of left and right boom foot backing portions 12S rotatably supports the boom foot 16S of the boom 16. The boom foot backing portions 12S each have a pin hole penetrating transversely. The boom foot 16S of the boom 16 also has a similar pin hole. When a coupling pin (not depicted) is inserted sequentially through the pin holes being matched each other, the boom 16 is supported on the upper slewing body 12 so as to be undulated.

The pair of left and right boom support receiving portions 121 is fixed to the slewing frame 120 at a position behind the boom foot backing portions 12S. Each of the boom support receiving portions 121 is a U-shaped receiving portion opened forward and upward. Each of the boom support receiving portions 121 receives (supports) the boom support contact portion 451S of the boom support 45. As depicted in FIG. 4, the boom support receiving portions 121 is disposed to project outward in the left-right direction from the slewing frame 120. This prevents interference between the winch 30 or the like (FIG. 1) disposed in a left-right center portion (center section) of the upper slewing body 12 and the boom support 45.

The pair of left and right base bodies 122 is disposed on the slewing frame 120 at a position just behind the boom foot backing portions 12S. Each of the base bodies 122 is a box-shaped member having an upper surface, a lower surface opposite to the upper surface, a right side surface and a left side surface connecting the upper surface and the lower surface, and a front surface and a rear surface. The slewing frame 120 supports the lower surface and left and right inner side surfaces of the base body 122. In comparison to a case where the base body 122 is constituted by a single board, the base body 122 having the box shape can be enhanced in rigidity and strength. Similarly to the slewing frame 120, the base body 122 is constituted by a steel member.

The pair of left and right boom stop receiving portions 123 is fixed respectively to the upper surfaces of the base bodies 122, and is constituted as U-shaped receiving portions opened forward and upward. Each of the boom stop receiving portions 123 has a function of receiving the boom stop contact portion 70S of the boom stop 70 to be described later.

The pair of left and right mast backing portions 124 constitutes part of the slewing frame 120 and is disposed above the base bodies 122. Each of the mast backing portions 124 rotatably supports the mast proximal end portion 17P (FIG. 1) of the lattice mast 17. The mast backing portion 124 has a pin hole 124H.

In a state depicted in FIG. 2, when the intermediate booms 16B, 16C, and 16D, and the upper boom 16E (FIG. 1) are sequentially coupled to the lower boom 16A to constitute the boom 16, the lattice mast 17 drags the boom 16 via the guylines 20 to cause the boom 16 to rise from the upper slewing body 12. In an exemplary case where an angle θ between a center line of the boom 16 and a horizontal line has 85 degrees as depicted in FIG. 3, the boom support contact portion 451S of the boom support 45 initially comes into contact with the boom support receiving portion 121, and the boom support spring 453 starts contracting. When the boom support spring 453 is contracted to a predetermined length, the boom 16 rises to an angle for normal operation. In this case, the boom stop contact portion 70S of the boom stop 70 is not in contact with the boom stop receiving portion 123.

In another exemplary case where the boom 16 is flapped backward by strong wind or the like and the angle θ of the boom 16 reaches 90 degrees (the maximum angle) while the crane 10 is in operation, the boom stop contact portion 70S of the boom stop 70 comes into contact with the boom stop receiving portion 123. The boom stop 70 receiving a maximum load (maximum reaction force) of the boom 16 is then interposed between the upper slewing body 12 and the boom 16 to prevent the boom 16 from falling backward.

In this case, the boom support spring 453 of the boom support 45 does not contract to the minimum length. In other words, the boom support 45 is not bottoming. This inhibits application of heavy self weight (load) of the boom 16 to the boom support 45 and the boom support receiving portion 121. When strong wind around the crane 10 stops, the boom 16 is pushed back by the bias force of the boom support spring 453 and the boom stop contact portion 70S moves away from the boom stop receiving portion 123.

When the boom undulation winch 38 depicted in FIG. 1 releases the boom undulation rope 22 during disassembly of the crane 10, the boom 16 starts being laid forward. The boom support spring 453 of the boom support 45 has elastic energy that is released to provide the boom support 45 with force of pushing the boom 16 forward. The boom 16 as a heavy object can be guided into the laid-down posture.

As described above, the present embodiment provides the crane 10 including the boom support 45 and the boom stop 70. The boom stop 70 can restrain the boom 16 from falling backward before the boom support spring 453 of the boom support 45 contracts to the minimum length. Accordingly, the boom support 45 including the boom support spring 453 has only to generate force of pushing back the boom 16 during disassembly of the crane. This inhibits application of the maximum load of the boom 16 to the boom support 45. Accordingly, even if increase in length of the boom 16, increase of attachments to the boom 16, or the like leads to increase in a wind receiving area of the boom 16, the boom 16 can stably be prevented from falling due to strong wind during normal operation and can be pushed back in the inverted direction during disassembly of the crane. Furthermore, this enables spring designing based on the pushing back force for the boom support spring 453 of the boom support 45, and achieves reduction in size and cost thereof. In comparison to the case where the boom support 45 receives the maximum load of the boom 16, the boom support lower portion 451 and the boom support upper portion 452 of the boom support 45 can then be decreased in outer diameter, thickness, and the like. Moreover, if reaction force received by the boom support 45 needs to be detected with use of a load cell (not depicted), the load cell can also be reduced in capacity.

The boom stop 70 according to the present embodiment is disposed to be interposed between the upper slewing body 12 and the boom 16, between the boom support 45 and the boom foot 16S in a direction parallel to the rotation center axis. The boom stop 70 is thus disposed closer to the boom foot 16S than the boom support 45 in this manner, so as to reliably restrain the boom 16 from falling backward as well as reliably inhibit application of the maximum load of the boom 16 to the boom support 45 disposed therebehind.

The present embodiment does not provide a single member, like a conventional backstop, with the function of preventing the boom 16 from falling backward and the function of pushing the boom 16 forward. Even when the boom 16 is increased in wind receiving area, this configuration reduces necessity for significant enhancement of rigidity and strength of the single member. The boom support 45 and the boom stop 70 each having a predetermined size and strength are dispersely disposed on the slewing frame 120, to enhance disposition flexibility of members on the slewing frame 120. In comparison to a backstop receiving portion configured to receive a distal end portion of the conventional backstop, the boom support receiving portion 121 can also be simplified in structure. The boom stop 70 according to the present embodiment does not need to be rotatably supported on the boom support backing portion 161S, and may have a constant relative angle to the lower boom 16A.

According to the present embodiment, when the boom 16 is in the rising state and the boom support 45 has the restrained length, the boom stop contact portion 70S comes into contact with the boom stop receiving portion 123 and the boom stop 70 thus receives the load of the boom 16. The boom stop receiving portion 123 provided on the upper slewing body 12 receives the boom stop contact portion 70S in this manner to stably prevent the boom 16 from falling due to strong wind or the like during normal operation.

Particularly in the present embodiment, the boom stop receiving portion 123 is disposed on the base body 122 having high strength for rotatable support of the boom foot 16S to more stably prevent the boom 16 from falling due to strong wind during normal operation.

Moreover, the boom stop backing portion 166 according to the present embodiment is disposed on the lower boom 16A at a position closer to the boom foot 16S than the longitudinal center portion of the lower boom 16A. This inhibits interference between the boom stop 70 and other members, such as the winches 34 and 36 depicted in FIG. 1, which are disposed at the distal end of the lower boom 16A. This enhances layout flexibility of members disposed on the lower boom 16A even when the lower boom 16A supports the boom stop 70.

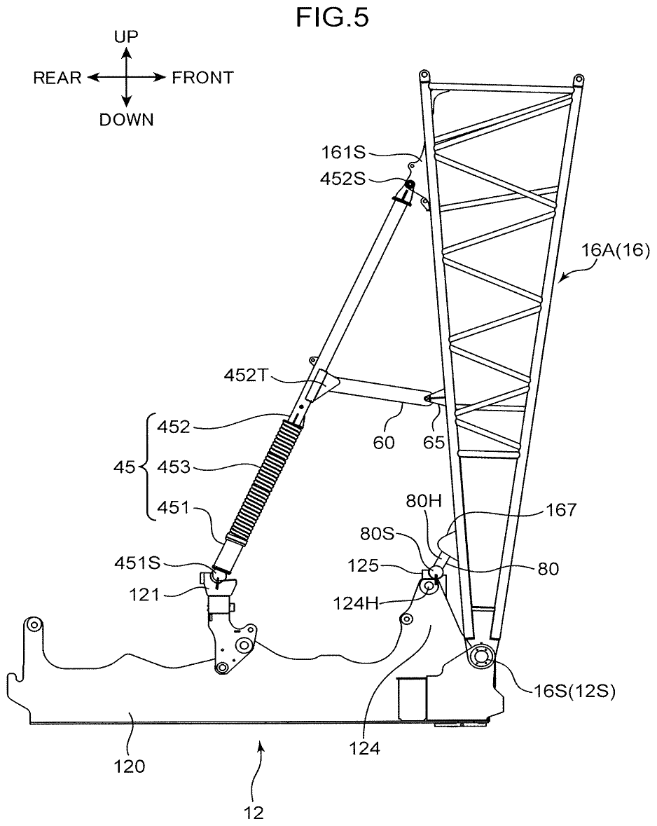

FIG. 5 is a side view of the boom 16 and the upper slewing body 12 of the crane 10 according to a variation example of the first embodiment. The first embodiment describes a mode in which the boom stop receiving portion 123 configured to receive the boom stop 70 is disposed on the base body 122. However, the present invention is not limited to such a mode. According to the variation example depicted in FIG. 5, a boom stop receiving portion 125 is disposed on the mast backing portion 124 provided in a front end portion of the slewing frame 120.

Meanwhile, a boom stop 80 is supported on a boom stop backing portion 167 provided on the lower boom 16A. As the boom 16 rises, a boom stop contact portion 80S of the boom stop 80 comes into contact with the boom stop receiving portion 125 to be received.

Also in the present variation example, the boom stop 80 can restrain the boom 16 from falling backward before the boom support spring 453 of the boom support 45 contracts to the minimum length. Accordingly, the boom support 45 including the boom support spring 453 has only to generate force of pushing back the boom 16 during disassembly of the crane. This inhibits application of the maximum load of the boom 16 to the boom support 45. Accordingly, even if increase in length of the boom 16, increase of attachments to the boom 16, or the like leads to increase in the wind receiving area of the boom 16, the boom 16 can stably be prevented from falling due to strong wind or the like during normal operation and can be pushed back in the inverted direction during disassembly of the crane, without any increase in the strength or the cost of the boom support spring 453.

In the present variation example, the boom stop receiving portion 125 is disposed on the mast backing portion 124 having high strength for support of the mast proximal end portion 17P of the lattice mast 17 to more stably prevent the boom 16 from falling due to strong wind or the like during normal operation. Moreover, in comparison to the boom stop 70 described earlier, the boom stop 80 can be shortened in length.

As to the boom stop 70 according to the first embodiment described earlier, a contact portion between the boom stop contact portion 70S and the boom stop receiving portion 123 is disposed at a left-right position identical to each of the end portions of the lower boom 16A. The boom stop backing portion 166 can thus be easily disposed on the first main pipe 161. In contrast, the boom stop backing portion 167 (FIG. 5) supporting the boom stop 80 has only to be disposed on the second connecting pipe (not depicted) transversely connecting the left and right first main pipes 161 (FIG. 2). According to another variation example, the crane 10 may include both the boom stop 70 and the boom stop 80 in addition to the boom support 45.

The above description refers to the crane 10 depicted in FIG. 1. However, the present invention is not limited to this crane, and is also applicable to a crane structured differently. Specifically, examples of the crane adopting the present invention may include a general purpose crane including a gantry in place of the lattice mast, and the undulation winch may be disposed on an upper frame (on a rear side) of the upper slewing body 12. The examples may also include a large crane having, instead of the SHL structure, a structure of undulating the boom by means of undulation of the box mast. In this case, there may not be provided the sheave block, and the guy link may directly connect the distal end portion of the box mast and the distal end portion of the boom. The general purpose crane and the large crane may each include a gib or a strut mounted in the distal end portion of the boom.

The above description refers to a mode in which the boom support 45 includes the boom support spring 453 and the boom support 45 is varied in length in accordance with contraction of the boom support spring 453. However, the present invention is not limited to such a mode. The boom support 45 may exemplarily have a hydraulic cylinder structure configured to be expanded and contracted by hydraulic force. In this case, the boom support lower portion 451 constitutes a cylinder body of the hydraulic cylinder, and the boom support upper portion 452 constitutes a cylinder rod of the hydraulic cylinder. The cylinder rod includes a piston portion partitioning the interior of the cylinder body into a head chamber and a rod chamber. When the head chamber receives hydraulic oil and the rod chamber discharges the hydraulic oil, the cylinder rod expands with respect to the cylinder body. When the rod chamber receives hydraulic oil and the head chamber discharges the hydraulic oil, the cylinder rod contracts with respect to the cylinder body. In the above configuration, alternatively, the boom support lower portion 451 may constitute the cylinder rod of the hydraulic cylinder, and the boom support upper portion 452 may constitute the cylinder body of the hydraulic cylinder.

Such a configuration also inhibits application of a heavy load to the boom support 45 because the boom stop 70 receives the load of the boom 16 before the boom support 45 is contracted by hydraulic pressure to the minimum length (before bottoming). The boom support 45 having the hydraulic cylinder configuration is thus reduced in necessity for increasing a cylinder diameter and necessity for increasing a rod diameter in order to receive a heavy load. Furthermore, a hydraulic circuit is also reduced in necessity for including a device or a pipe durable against high pressure.

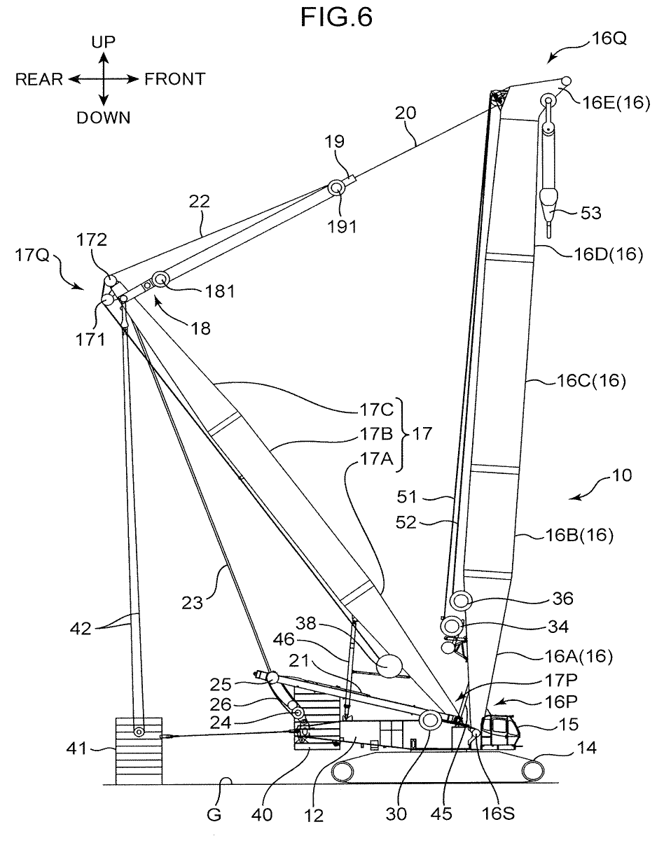

Description is made next to a second embodiment of the present invention. FIG. 6 is a side view of a crane 10 (working machine) according to the present embodiment. Hereinafter, each drawing includes indication of directions of “up”, “down”, “front”, and “rear”. These directions are indicated for convenience in description of a structure and an assembling method of the crane 10 according to the present embodiment, and do not limit any shifting direction, any use mode, or the like of the crane according to the present invention. The following description refers mainly to differences from the first embodiment.

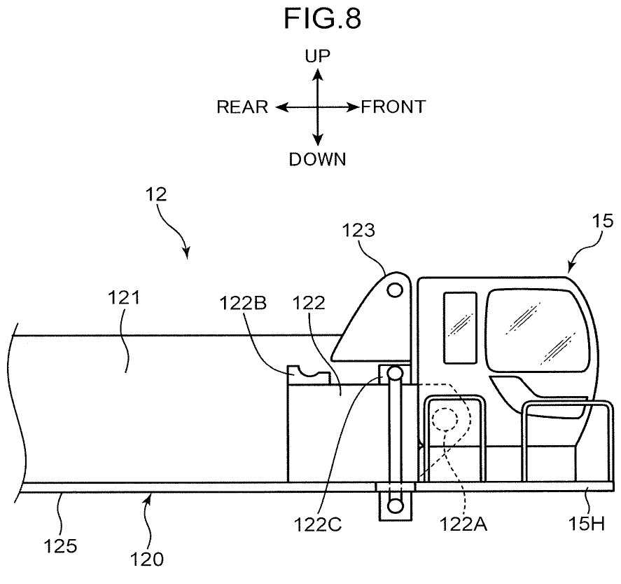

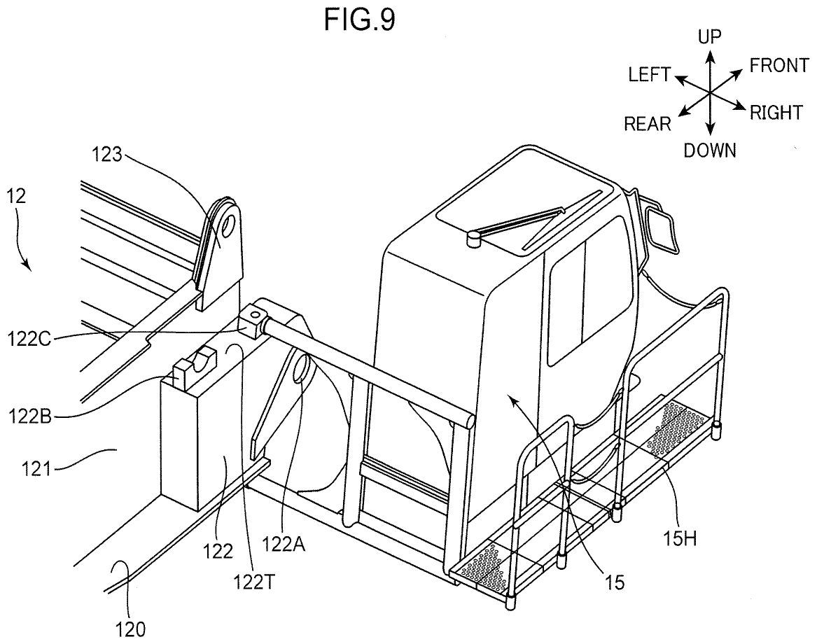

The boom proximal end portion 16P according to the present embodiment includes the boom foot 16S (undulating body fulcrum) that is supported to be rotatable in the undulation direction on a boom backing portion 122A (FIG. 8 and FIG. 9) to be described later of the upper slewing body 12. The lower boom 16A is provided with a pair of left and right backstops 45. These backstops 45 each come into contact with the upper slewing body 12 when the boom 16 reaches the rising posture (the working posture) depicted in FIG. 6 with respect to the upper slewing body 12, to be interposed between the boom 16 and the upper slewing body 12 and support the boom 16 from behind. This restrains the boom 16 from being flapped backward by strong wind or the like. The backstops 45 will be described in detail later in terms of their structure.

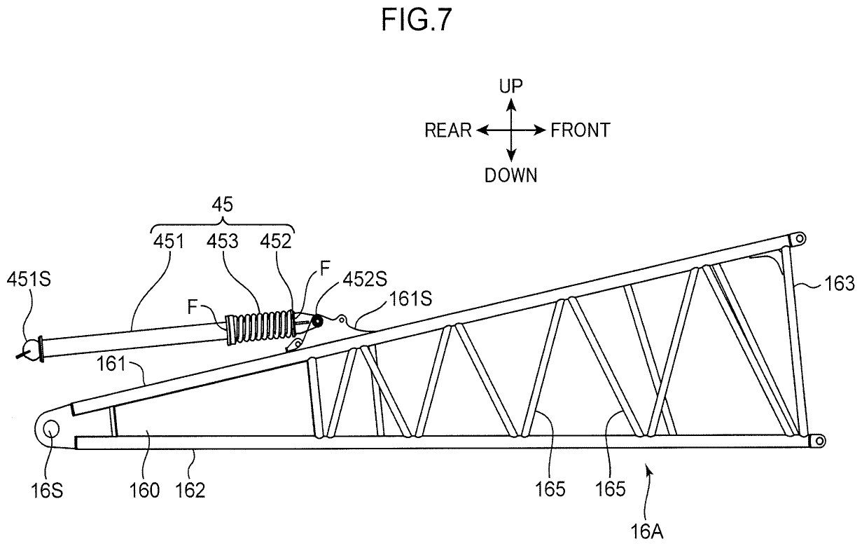

FIG. 7 is a side view of the lower boom 16A and the backstop 45 in a state where the boom 16 of the crane 10 according to the present embodiment is in the laid-down posture.

Also in the present embodiment, the lower boom 16A includes a pair of left and right backstop backing portions 161S (backstop first backing portions). The pair of left and right backstop backing portions 161S is disposed respectively on the pair of left and right first main pipes 161 (the back surface of the lower boom 16A) at positions closer to the distal ends than the boom foot 16S, more specifically, closer to the boom foot 16S than the longitudinal center portion of the lower boom 16A. The backstop backing portions 161S support backstop proximal end portions 452S (first end portions) of the backstops 45 to be described later.

As described earlier, the crane 10 includes the pair of left and right backstops 45. The backstops 45 are disposed on the pair of left and right first main pipes 161. The pair of left and right backstops 45 are identical in terms of their structure and their function. Accordingly, described hereinafter will be the backstop 45 on the right side (a near side on a sheet of FIG. 7).

The backstop 45 includes a backstop lower portion 451 (also referred to as an inner cylinder), a backstop upper portion 452 (also referred to as an outer cylinder), and a backstop spring 453 (also referred to as a spring member). The backstop lower portion 451 and the backstop upper portion 452 each have a cylinder structure, and the backstop lower portion 451 is expandably inserted to a cylindrical inner space of the backstop upper portion 452. The backstop spring 453 is mounted so as to be contracted and deformed between the flanges F (FIG. 7) provided respectively on the backstop lower portion 451 and the backstop upper portion 452.

The backstop lower portion 451 includes a backstop contact portion 451S (second end portion), and the backstop upper portion 452 includes the backstop proximal end portion 452S (first end portion). The backstop proximal end portion 452S corresponds to a proximal end portion of the backstop 45, and the backstop contact portion 451S corresponds to a distal end portion of the backstop 45 opposite to the backstop proximal end portion 452S. As described above, the backstop proximal end portion 452S is supported on (mounted to) the backstop backing portion 161S disposed in a portion closer to the distal end portion (the boom distal end portion 16Q) of the lower boom 16A than the boom foot 16S.

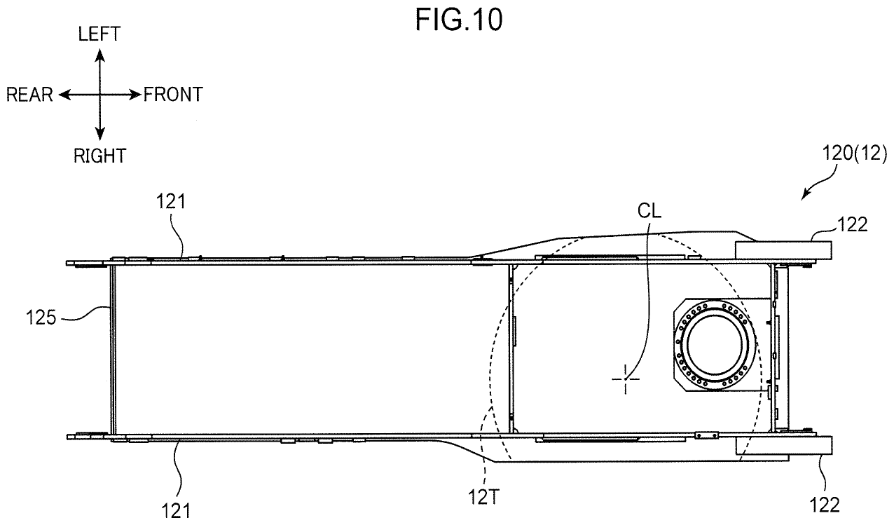

FIG. 8 and FIG. 9 are an enlarged side view and an enlarged perspective view of part of the upper slewing body 12 of the crane 10 according to the present embodiment. FIG. 10 is a plan view of the slewing frame 120 of the upper slewing body 12 according to the present embodiment. The upper slewing body 12 includes the slewing frame 120. The slewing frame 120 includes a bottom plate 125 and a pair of left and right longitudinal plates 121 fixed onto the bottom plate 125. The crane 10 further includes a slew bearing 12T. The slew bearing 12T is disposed to be interposed between the lower travelling body 14 and the upper slewing body 12, and allows the upper slewing body 12 to slew about a slew center axis CL extending in an up-down direction with respect to the lower travelling body 14. FIG. 10 indicates an outer diameter of the slew bearing 12T by broken line.

The bottom plate 125 is supported to be slewable on the lower travelling body 14. The bottom plate 125 is a member extending in the front-back direction and the left-right direction, and is exemplarily constituted by a frame of joint steel members. The pair of left and right longitudinal plates 121 is plate-shaped members extending in the front-back direction to have a large length, is fixed to (stands on) the bottom plate 125 with a left-right interval therebetween, and is also constituted by a steel member or the like. FIG. 8 and FIG. 9 each depict only the longitudinal plate 121 on the right side (a near side on a sheet).

The upper slewing body 12 further includes the pair of left and right base bodies 122 having a box shape and a pair of left and right mast backing portions 123. The base bodies 122 are each disposed outside a corresponding one of the longitudinal plates 121 at a distal end of the corresponding longitudinal plate 121. The pair of mast backing portions 123 is disposed in distal end portions and upper end portions of the longitudinal plates 121, and rotatably supports the mast proximal end portion 17P (FIG. 6) of the lattice mast 17.

As depicted in FIG. 8 and FIG. 9, the base body 122 on the right side is described in more detail below in terms of its peripheral structure. The base body 122 on the left side has a peripheral structure transversely symmetrical with respect to the structure on the right side. The base body 122 is a box-shaped member having an upper surface 122T, a lower surface opposite to the upper surface 122T, a right side surface and a left side surface connecting the upper surface and the lower surface, and a front surface and a rear surface. As depicted in FIG. 9, the lower surface of the base body 122 is supported by the bottom plate 125. The left side surface of the base body 122 is connected to the longitudinal plate 121. As depicted in FIG. 8, the base body 122 includes a front portion having a triangular shape projecting forward. In comparison to a case where the base body 122 is constituted by a single board, the base body 122 having the box shape can be enhanced in rigidity and strength. Similarly to the bottom plate 125, the base body 122 is also constituted by a steel member.

The base body 122 includes the boom backing portion 122A (undulating body backing portion), a backstop receiving portion 122B (backstop second backing portion), and a cab backing portion 122C.

The boom backing portion 122A rotatably supports the boom foot 16S about a horizontal rotation center axis extending transversely. The boom backing portion 122A is disposed in a front end portion of the base body 122, specifically, the triangular portion. The boom backing portion 122A has a pin hole transversely penetrating the base body 122. The boom foot 16S of the boom 16 also has a similar pin hole. When a coupling pin (not depicted) is inserted sequentially through the pin holes being matched each other, the boom 16 is supported on the upper slewing body 12 so as to be undulated. Though not depicted, the same applies the base body 122 on the left side.

The backstop receiving portion 122B is disposed behind the boom backing portion 122A and supports the backstop contact portion 451S of the backstop 45. The backstop receiving portion 122B is disposed in a rear end portion of the base body 122. Specifically, the backstop receiving portion 122B is disposed at a rear end of the upper surface 122T of the base body 122, and is a U-shaped receiving portion opened forward and upward. When the boom 16 has the rising posture depicted in FIG. 6, the backstop receiving portion 122B supports the backstop contact portion 451S of the backstop 45 and receives self weight of the boom 16 via the backstop 45. The backstop receiving portion 122B depicted in FIG. 8 and FIG. 9 is disposed ahead of the slew center axis CL indicated in FIG. 10 on the slewing frame 120 in the front-back direction of the upper slewing body 12. The backstop receiving portion 122B constitutes the assistance structure according to the present invention. The assistance structure assists the pair of left and right backstops 45 in supporting the boom 16.

The cab backing portion 122C is disposed ahead of the backstop receiving portion 122B on the upper surface of the base body 122. The cab backing portion 122C has a function of supporting the cab 15, a step 15H, and the like via a different pillar and the like.

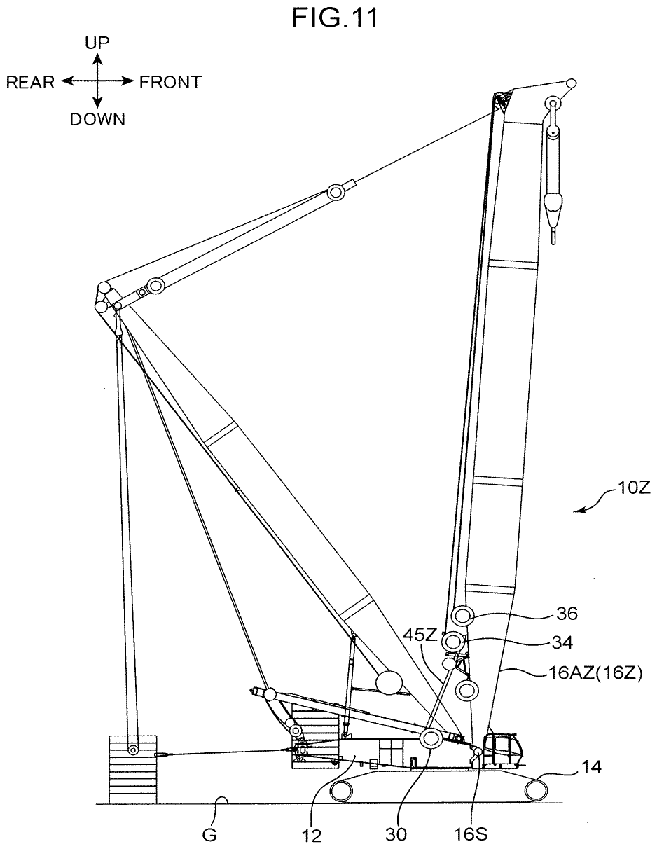

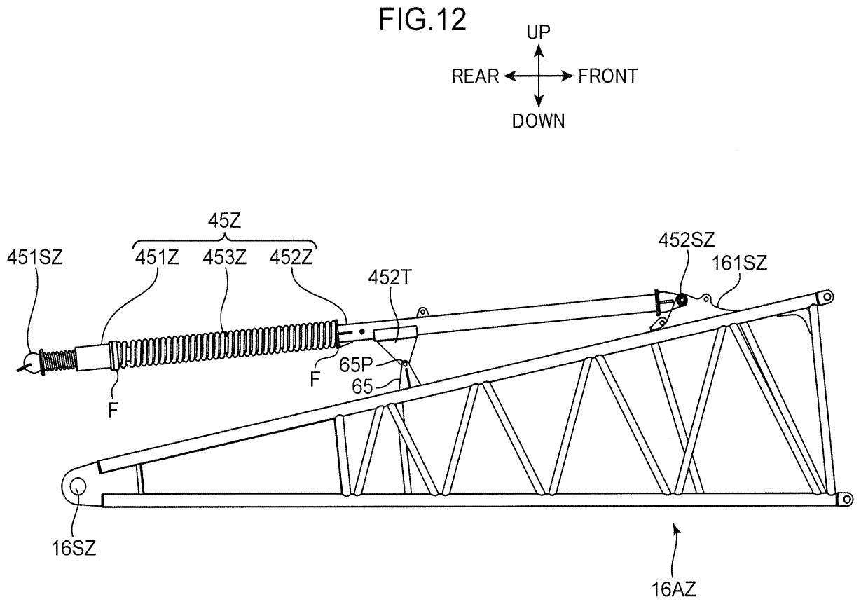

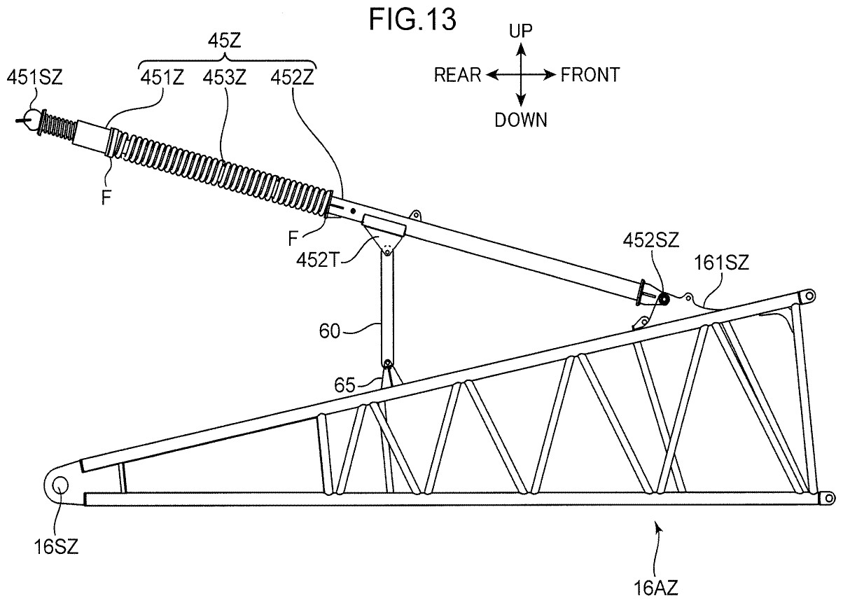

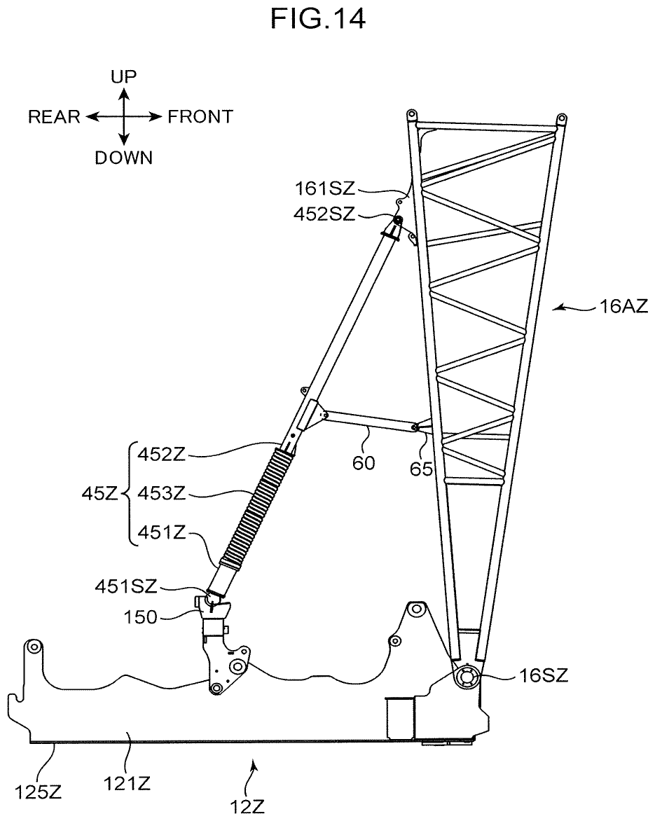

FIG. 11 is a side view of a conventional crane 10Z to be compared with the crane 10 according to the present embodiment. FIG. 12 is a side view of a lower boom 16AZ and a backstop 45Z in a state where a boom 16Z of the conventional crane 10Z is in a laid-down posture. FIG. 13 is a side view of the lower boom 16AZ and the backstop 45Z when the backstop 45Z rises from a state where the boom 16Z of the conventional crane 10Z is in the laid-down posture. FIG. 14 is a side view of the lower boom 16AZ, an upper slewing body 12Z, and the backstop 45Z in the state where the boom 16Z of the conventional crane 10Z is in a rising posture. Members depicted in FIG. 11 to FIG. 14 and in common with corresponding members depicted in FIG. 6 are denoted by the same reference signs followed by Z.

The crane 10Z includes the backstop 45Z. The backstop 45Z is supported on the lower boom 16AZ so as to rise. The backstop 45Z is rotatably supported on the lower boom 16AZ. The backstop 45Z includes a backstop lower portion 451Z, a backstop upper portion 452Z, and a backstop spring 453Z. The backstop lower portion 451Z includes a backstop contact portion 451SZ. The backstop upper portion 452Z includes a backstop proximal end portion 452SZ and the supported portion 452T.

Meanwhile, with reference to FIG. 12, the lower boom 16AZ includes a boom foot 16SZ, a backstop backing portion 161SZ, and a backstop fixed portion 65. The backstop backing portion 161SZ rotatably supports the backstop proximal end portion 452SZ of the backstop 45Z about a rotation center axis extending transversely. As depicted in FIG. 12, when the backstop 45Z is retained on the lower boom 16A, a pin 65P is inserted through pin holes opened in the supported portion 452T and the backstop fixed portion 65 to fix the backstop 45Z. As depicted in FIG. 13, in order that the backstop 45Z rises from the lower boom 16AZ, the supported portion 452T and the backstop fixed portion 65 interpose a support member 60 to keep a rising posture of the backstop 45Z with respect to the lower boom 16AZ.

With reference to FIG. 14, in the conventional crane 10Z thus configured, the upper slewing body 12Z is provided with a backstop receiving portion 150 at a position behind the boom foot 16SZ. When the boom 16Z rises from the upper slewing body 12Z, the backstop contact portion 451SZ of the backstop 45Z comes into contact with the backstop receiving portion 150 to support the boom 16Z from behind. In such a configuration in which the backstop 45Z is supported by both the backstop backing portion 161SZ disposed at a distal end of the lower boom 16AZ and the backstop receiving portion 150 disposed in a center portion of a bottom plate 125Z, the backstop 45 is inevitably increased in free length. In other words, increased is a contraction stroke in which the backstop spring 453Z is contracted and deformed to the minimum length after the backstop contact portion 451SZ comes into contact with the backstop receiving portion 150 along with rising motion of the boom 16Z. For example, the stroke may need to have about 500 mm. In this case, the backstop spring 453Z tends to be increased in cost in order to secure the contraction stroke of the backstop 45Z. As depicted in FIG. 12 and FIG. 13, in a state where the boom 16Z is laid down with respect to the upper slewing body 12Z, the backstop 45Z extends from the lower boom 16AZ with a long entire length. When the boom 16Z and the backstop 45Z are transported integrally or when the backstop 45Z detached from the lower boom 16AZ is transported, the backstop 45Z problematically occupies a large space. As depicted in FIG. 12 and FIG. 13, there is also needed a mechanism (the support member 60) configured to change the posture of the backstop 45Z.

Moreover, the lower boom 16AZ has a portion closer to the distal end than a longitudinal center portion and provided with members such as the winches 34 and 36 and the guy link (not depicted) as depicted in FIG. 11. Accordingly, the backstop backing portion 161SZ supporting the backstop proximal end portion 452SZ tends to be limited in space for disposition. Furthermore, the upper slewing body 12Z is often provided with an engine and the like around a front-back center portion. Accordingly, the backstop receiving portion 150 depicted in FIG. 14 is problematically limited in space for disposition. In this case, the backstop receiving portion 150 has a complex shape in order to avoid interference with peripheral members, and may further need a reinforce in order to stably support self weight of the boom 16Z.

In contrast, according to the present embodiment, when the boom 16 including the lower boom 16A depicted in FIG. 7 rises, the backstop contact portion 451S of the backstop 45 comes into contact with the backstop receiving portion 122B (FIG. 8, FIG. 9) of the base body 122 to be supported (FIG. 6). The backstop receiving portion 122B is disposed ahead of the slew center axis CL (FIG. 10) and behind the boom backing portion 122A in the front-back direction of the upper slewing body 12. In comparison to a case where the backstop receiving portion 122B is disposed behind the slew center axis CL, the backstop 45 can be decreased in contraction stroke. The backstop receiving portion 122B is disposed ahead of the slew center axis CL in this manner to enhance layout flexibility in the center portion of the upper slewing body 12. Furthermore, the upper slewing body 12 has a region ahead of the slew center axis CL and provided with the boom backing portion 122A in addition to the slew bearing 12T, and is thus inevitably required to have high rigidity and strength. When the backstop receiving portion 122B is disposed in such a region, the backstop 45 can stably support the boom 16.

The backstop receiving portion 122B according to the present embodiment is disposed on the base body 122 along with the boom backing portion 122A, and is thus disposed closer to the boom backing portion 122A in the front-back direction. Accordingly decreased is the contraction stroke in which the backstop spring 453 is deformed to the minimum length after the backstop contact portion 451S comes into contact with the backstop receiving portion 122B. For example, the stroke has about 100 mm to 200 mm. As depicted in FIG. 8 and FIG. 9, the backstop receiving portion 122B is disposed close to the boom backing portion 122A. This further enhances layout flexibility in the center portion of the upper slewing body 12, specifically, a peripheral portion of the mast undulation winch 30 depicted in FIG. 6, and a power unit such as an engine can be disposed more easily in comparison to a conventional case.

In the present embodiment, the backstop 45 is disposed close to the boom foot 16S as depicted in FIG. 6. The backstop receiving portion 122B is thus likely to receive a heavier load for inhibiting the boom 16 from falling backward. However, the box-shaped base body 122 provided with the boom backing portion 122A configured to support the boom 16 is similarly provided with the backstop receiving portion 122B in the present embodiment. The boom 16 can thus be stably supported from behind due to light weight and high strength characteristics of the base body 122.

In particular, the backstop receiving portion 122B is disposed on the upper surface 122T of the base body 122, and can thus more stably receive the load of the boom 16.

The boom backing portion 122A is disposed in the front end portion of the base body 122, whereas the backstop receiving portion 122B is disposed in the rear end portion of the base body 122. The boom foot 16S and the backstop 45 can thus secure a maximum perpendicular distance therebetween on the base body 122.

In the present embodiment, the lower surface of the base body 122 is supported by the bottom plate 125 and the side surface of the base body 122 is supported by the longitudinal plate 121. Accordingly, the base body 122 is disposed where the bottom plate 125 and the longitudinal plate 121 cross each other. The base body 122 can thus be stably supported by the bottom plate 125 and the longitudinal plate 121.

In the present embodiment, the backstop proximal end portion 452S of the backstop 45 is coupled to the backstop backing portion 161S such that the backstop 45 and the boom 16 integrally rotate relatively to the upper slewing body 12. When the boom 16 rises from the upper slewing body 12, the backstop contact portion 451S of the backstop 45 comes into contact with the backstop receiving portion 122B to restrain further backward rotation of the boom 16. In such a configuration, the backstop 45 as well as the boom 16 can be detached from the upper slewing body 12. The lower boom 16A and the backstop 45 can thus be transported and stored integrally.

In the present embodiment, the backstop proximal end portion 452S of the backstop 45 is fixed to the backstop backing portion 161S (FIG. 7) such that the backstop 45 keeps a posture relative to the lower boom 16A (boom 16) in the direction parallel to the rotation center axis of the boom 16. In other words, the backstop 45 according to the present embodiment does not need to be rotatably supported to the lower boom 16A with a conventional large movable range. The backstop 45 can thus have an identical posture during use and disassembly of the crane 10. This reduces conventional posture changing work and necessity for a device therefor.

The boom 16 according to the present embodiment can be divided into a plurality of members, and includes at least the lower boom 16A including the boom foot 16S. In a state where the boom 16 rises from the upper slewing body 12 such that the center line of the boom 16 extends vertically, the backstop contact portion 451S of the backstop 45 is disposed ahead of a rear end portion of the lower boom 16A. This also means that the backstop 45 stays within a maximum height of the lower boom 16A being laid down as depicted in FIG. 7. More specifically, when the boom 16 has the rising posture of being directed vertically upward and the lower boom 16A is projected on the upper slewing body 12 in a planar view, the backstop contact portion 451S is positioned ahead of a rear end portion of a projected region. In such a configuration, the backstop 45 can be transported along with the lower boom 16A while satisfying a transport height limit without detaching the backstop 45 from the lower boom 16A or largely changing the posture of the backstop 45.

Moreover, the backstop backing portion 161S according to the present embodiment is disposed on the lower boom 16A at a position closer to the boom foot 16S than the longitudinal center portion of the lower boom 16A. This inhibits interference between the backstop 45 and members, such as the winches 34 and 36 depicted in FIG. 6, disposed at the distal end of the lower boom 16A, and enhances layout flexibility of members disposed on the lower boom 16.

Described above is the crane 10 according to the second embodiment of the present invention. Note that the present invention is not limited to these embodiments. The present invention can include the following variation embodiments.

The second embodiment refers to a mode in which the backstop proximal end portion 452S of the backstop 45 is supported on the lower boom 16A, and the backstop contact portion 451S comes into the backstop receiving portion 122B provided on the upper slewing body 12 along with rising motion of the boom 16. However, the present invention is not limited to such a mode.

The backstop 45 according to the second embodiment may preliminarily be supported on the upper slewing body 12. Specifically, the backstop proximal end portion 452S (second end portion) of the backstop 45 may be coupled to the backstop backing portion (backstop second backing portion) provided on the base body 122 and shaped similarly to the backstop backing portion 161S such that the boom 16 rotates relatively to the backstop 45 and the upper slewing body 12. When the boom 16 rises from the upper slewing body 12 in this case, the backstop contact portion 451S (first end portion) of the backstop 45 comes into contact with the backstop receiving portion (backstop first backing portion) provided on the lower boom 16A and shaped similarly to the backstop receiving portion 122B to restrain further backward rotation of the boom 16.

In such a configuration, the backstop 45 is disposed adjacent to the upper slewing body 12, and an attachment and the like of the lower boom 16A can thus have more enhanced layout flexibility.

The second embodiment refers to the crane 10 depicted in FIG. 6. However, the present invention is not limited to this crane, and is also applicable to a crane structured differently as in the first embodiment described earlier.

The second embodiment describes a mode in which the backstop 45 extends along the first main pipe 161 of the lower boom 16A as depicted in FIG. 7. The backstop 45 may alternatively be disposed to cross the first main pipe 161 at a larger angle. When the backstop 45 is disposed to be perpendicular to the first main pipe 161, the backstop 45 can efficiently receive self weight of the boom 16.

The second embodiment describes a mode in which the backstop receiving portion 122B is disposed ahead of the slew center axis CL, that is, in a front half region of the slew bearing 12T. However, the present invention is not limited to such a mode. In an exemplary case where the crane 10 has a middle or small size or a large size, the backstop receiving portion 122B may alternatively be disposed in a predetermined region ahead of the slew center axis CL as a starting point. Still alternatively, the backstop receiving portion 122B may be disposed in a predetermined region behind a front end portion of the slew bearing 12T as a starting point. In this case, each of the predetermined regions has an front-back length desirably corresponding to two-thirds of a length from the slew center axis CL to the front end portion of the slew bearing 12T.

When the crane 10 has a large size, the backstop receiving portion 122B may be disposed in a predetermined region ahead of or behind the slew center axis CL as a starting point (a region adjacent to a point where the longitudinal plate 121 and the slew bearing 12T are in contact with each other or cross each other). In this case, the predetermined region has an front-back length desirably corresponding to two-thirds of a length from the slew center axis CL to the front end portion or a rear end portion of the slew bearing 12T. The base body 122 or the backstop receiving portion 122B is preferably disposed in a region including the slew center axis CL (region overwrapped with the slew center axis CL) in the front-back direction. The slew bearing 12T is positioned at a left-right end in each of these regions, and the backstop receiving portion 122B can thus be disposed stably and firmly.

The second embodiment describes a mode in which the backstop receiving portion 122B is disposed on the box-shaped base body 122. Alternatively, the backstop receiving portion 122B may not be disposed on the base body 122. The base body 122 may alternatively have a shape different from the box shape. For example, the boom backing portion 122A is constituted by a single or a plurality of plate-shaped members, and the backstop receiving portion 122B may be a different structural body disposed adjacent to the boom backing portion 122A. In this case, the structural body may be constituted by combined plate-shaped members or have a bracket structure.

The second embodiment describes a mode in which the backstop spring 453 is disposed adjacent to the backstop proximal end portion 452S as depicted in FIG. 7. Alternatively, the backstop spring 453 may be disposed adjacent to the backstop contact portion 451S (FIG. 7) as depicted in FIG. 12.

As described above, the present invention provides a crane. The crane includes: a crane body; an undulating body including an undulating body fulcrum supported on the crane body to be rotatable in an undulation direction about a rotation center axis extending horizontally; a backstop being expandable, having a first end portion and a second end portion, and interposed between the undulating body and the crane body in a state where the undulating body rises from the crane body to support the undulating body from behind; and an assistance structure configured to assist the backstop in supporting the undulating body.

This configuration can stably prevent the undulating body from falling due to strong wind or the like during normal operation without increase in strength or cost of a member supporting the undulating body.

In the above configuration, possibly, the backstop includes an outer cylinder and an inner cylinder inserted to the outer cylinder, is expandable between a maximum length and a minimum length, and is interposed between the crane body and the undulating body in a rising state where the undulating body rises from the crane body to support the undulating body from behind while applying forward bias force to the undulating body, and the assistance structure includes a restraining member configured to be interposed between the crane body and the undulating body and receive a load of the undulating body to restrain the undulating body from falling backward when the undulating body is in the rising state and the backstop has a predetermined restrained length between the maximum length and the minimum length.

In this configuration, the restraining member can restrain the undulating body from falling backward before the backstop contracts to the minimum length. This inhibits application of a maximum load of the undulating body to the backstop. Accordingly, even if increase in length of the undulating body, increase of attachments to the undulating body, or the like leads to increase in a wind receiving area of the undulating body, the undulating body can stably be prevented from falling due to strong wind or the like during normal operation and can be pushed back in an inverted direction during disassembly of the crane, without any increase in the strength or the cost of the backstop.

In the above configuration, possibly, the backstop further includes a spring member disposed to be interposed between the outer cylinder and the inner cylinder and configured to be contractive between a maximum spring length and a minimum spring length, and is interposed between the undulating body and the crane body to support the undulating body from behind while applying forward bias force to the undulating body when the undulating body is in the rising state and the spring member is contracted from the maximum spring length, and the restraining member is interposed between the crane body and the undulating body and receives the load of the undulating body to restrain the undulating body from falling backward when the undulating body is in the rising state and the backstop has the restrained length with the spring member is contracted to a length between the maximum spring length and the minimum spring length.

In this configuration, the restraining member can restrain the undulating body from falling backward before spring member of the backstop contracts to the minimum length. The backstop including the spring member can thus be inhibited from receiving the maximum load of the undulating body. Accordingly, even if increase in length of the undulating body, increase of attachments to the undulating body, or the like leads to increase in the wind receiving area of the undulating body, the undulating body can stably be prevented from falling due to strong wind or the like during normal operation and can be pushed back in the inverted direction during disassembly of the crane, without any increase in the strength or the cost of the spring member.

In the above configuration, desirably, the restraining member is disposed to be interposed between the crane body and the undulating body at a position between the backstop and the undulating body fulcrum in a direction parallel to the rotation center axis.

In this configuration, the restraining member is disposed closer to the undulating body fulcrum than the backstop, so as to reliably restrain the undulating body from falling backward as well as reliably inhibit application of the maximum load of the undulating body to the backstop disposed therebehind.

In the above configuration, desirably, the restraining member includes a restraining member proximal end portion supported on the undulating body and a restraining member distal end portion opposite to the restraining member proximal end portion, and is disposed to project from the undulating body, the crane body includes a restraining member receiving portion configured to receive the restraining member distal end portion, and the restraining member receives the load of the undulating body with the restraining member distal end portion being in contact with the restraining member receiving portion when the undulating body is in the rising state and the spring member has the restrained length.

In this configuration, the restraining member receiving portion receives the restraining member distal end portion to stably prevent the undulating body from falling due to strong wind or the like during normal operation.

In the above configuration, desirably, the crane body includes a slewing frame, and a support frame disposed in a front end portion of the slewing frame and including an undulating body backing portion rotatably supporting the undulating body fulcrum, and the restraining member receiving portion is disposed on the support frame.

In this configuration, the restraining member receiving portion is disposed on the support frame having high strength for rotatable support of the undulating body fulcrum to more stably prevent the undulating body from falling due to strong wind or the like during normal operation.

In the above configuration, possibly, the crane further includes a mast including a mast proximal end portion rotatably supported on the crane body at a position behind the undulating body, the mast supporting the undulating body from behind, the crane body includes a slewing frame, the slewing frame includes a mast backing portion rotatably supporting the mast proximal end portion, and the restraining member receiving portion is disposed on the mast backing portion.

In this configuration, the restraining member receiving portion is disposed on the mast backing portion having high strength for support of the mast proximal end portion to more stably prevent the undulating body from falling due to strong wind or the like during normal operation.

In the above configuration, desirably, the undulating body is dividable into a plurality of members, and includes at least an undulating body lower member including the undulating body fulcrum, and the restraining member proximal end portion is supported on the undulating body lower member in a portion closer to the undulating body fulcrum than a longitudinal center portion of the undulating body lower member.

This configuration inhibits interference between the restraining member and a different member disposed at a distal end of the undulating body lower member, and enhances layout flexibility of the member disposed on the undulating body lower member. In the crane provided by the present invention, possibly, the crane body includes a lower travelling body, an upper slewing body disposed above the lower travelling body, and a slew bearing disposed to be interposed between the lower travelling body and the upper slewing body, and configured to allow the upper slewing body to slew about a slew center axis extending in an up-down direction with respect to the lower travelling body, the undulating body fulcrum is supported on the upper slewing body to be rotatable in the undulation direction, the undulating body includes a backstop first backing portion disposed closer to a distal end than the undulating body fulcrum and supporting the first end portion of the backstop, and the upper slewing body includes an undulating body backing portion rotatably supporting the undulating body fulcrum about the rotation center axis extending horizontally, and a backstop second backing portion disposed ahead of the slew center axis and behind the undulating body backing portion in a front-back direction of the upper slewing body, and supporting the second end portion of the backstop as the assistance structure.

In this configuration, the backstop second backing portion supporting the second end portion of the backstop is disposed ahead of the slew center axis and behind the undulating body backing portion in the front-back direction of the upper slewing body. In comparison to a case where the backstop second backing portion is disposed behind the slew center axis, the backstop can be decreased in contraction stroke. The backstop second backing portion is disposed ahead of the slew center axis to enhance layout flexibility in a center portion of the upper slewing body. Moreover, the upper slewing body has a region ahead of the slew center axis and provided with the undulating body backing portion as well as the slew bearing. This region is thus inevitably required to have high rigidity and strength. When the backstop second backing portion is disposed in such a region, the backstop can thus stably support the undulating body.

In the above configuration, possibly, the upper slewing body further includes a base body having a box shape and including the undulating body backing portion and the backstop second backing portion.

In this configuration, the backstop second backing portion is disposed on the box-shaped base body along with the undulating body backing portion, and is thus disposed closer to the undulating body backing portion in the front-back direction. The backstop is then decreased in contraction stroke after the backstop starts supporting the undulating body. The backstop second backing portion is disposed close to the undulating body backing portion to further enhance layout flexibility in the center portion of the upper slewing body. Moreover, the backstop second backing portion is disposed on the box-shaped base body supporting the undulating body. The undulating body can thus be stably supported due to light weight and high strength characteristics of the box shape.

In the above configuration, possibly, the base body has an upper surface, and the backstop second backing portion is disposed on the upper surface.

In this configuration, the backstop second backing portion is disposed on the upper surface of the base body, and can thus more stably receive the load of the undulating body.

In the above configuration, possibly, the undulating body backing portion is disposed in a front end portion of the base body, and the backstop second backing portion is disposed in a rear end portion of the base body.

This configuration can secure a maximum perpendicular distance between the undulating body fulcrum and the backstop on the base body.

In the above configuration, possibly, the upper slewing body includes a bottom plate supported to be slewable on the lower travelling body, and a longitudinal plate standing to extend in the front-back direction on the bottom plate, and the base body has a lower surface opposite to the upper surface and supported on the bottom plate, and a side surface connecting the upper surface and the lower surface and connected to the longitudinal plate.

In this configuration, the base body is disposed where the bottom plate and the longitudinal plate cross each other. The base body can thus be stably supported by the bottom plate and the longitudinal plate.

In the above configuration, possibly, the first end portion of the backstop is coupled to the backstop first backing portion to allow the backstop to rotate integrally with the undulating body relatively to the upper slewing body, and when the undulating body rises from the upper slewing body, the second end portion of the backstop comes into contact with the backstop second backing portion to restrain further backward rotation of the undulating body.

In this configuration, the backstop as well as the undulating body can be detached from the upper slewing body. The undulating body and the backstop can thus be transported and stored integrally.

In the above configuration, possibly, the first end portion of the backstop is supported on the backstop first backing portion to keep a posture of the backstop relative to the undulating body in a direction parallel to the rotation center axis.

In this configuration, the backstop can have an identical posture during use and disassembly of the crane. This reduces conventional posture changing work and necessity for a device therefor.

In the above configuration, possibly, the undulating body is dividable into a plurality of members, and includes at least an undulating body lower member including the undulating body fulcrum, and the second end portion of the backstop is disposed ahead of a rear end portion of the undulating body lower member in a state where the undulating body rises from the upper slewing body to have a center line extending vertically.

In this configuration, the backstop stays within a maximum height of the undulating body lower member being laid down. Accordingly, the backstop can be transported along with the undulating body lower member while satisfying a transport height limit without changing the posture of the backstop or detaching the backstop.

In the above configuration, possibly, the second end portion of the backstop is coupled to the backstop second backing portion to allow the undulating body to rotate relatively to the backstop and the upper slewing body, and when the undulating body rises from the upper slewing body, the first end portion of the backstop comes into contact with the backstop first backing portion to restrain further backward rotation of the undulating body.

In this configuration, the backstop is disposed on the upper slewing body, and an attachment of the undulating body can thus have more enhanced layout flexibility.

In the above configuration, possibly, the undulating body is dividable into a plurality of members, and includes at least an undulating body lower member including the undulating body fulcrum, and the backstop first backing portion is disposed on the undulating body lower member at a position closer to the undulating body fulcrum than a longitudinal center portion of the undulating body lower member.

This configuration inhibits interference between the backstop first backing portion and a different member disposed at the distal end of the undulating body lower member, and enhances layout flexibility of the member disposed on the undulating body lower member.

1. A crane comprising:
a crane body;
an undulating body including an undulating body fulcrum supported on the crane body to be rotatable in an undulation direction about a rotation center axis extending horizontally;
a backstop being expandable, having a first end portion and a second end portion, and interposed between the undulating body and the crane body in a state where the undulating body rises from the crane body to support the undulating body from behind; and
an assistance structure configured to assist the backstop in supporting the undulating body.

2. The crane according to claim 1, wherein
the backstop includes an outer cylinder and an inner cylinder inserted to the outer cylinder, is expandable between a maximum length and a minimum length, and is interposed between the crane body and the undulating body in a rising state where the undulating body rises from the crane body to support the undulating body from behind while applying forward bias force to the undulating body, and
the assistance structure includes a restraining member configured to be interposed between the crane body and the undulating body and receive a load of the undulating body to restrain the undulating body from falling backward when the undulating body is in the rising state and the backstop has a predetermined restrained length between the maximum length and the minimum length.

3. The crane according to claim 2, wherein
the backstop further includes a spring member disposed to be interposed between the outer cylinder and the inner cylinder and configured to be contractive between a maximum spring length and a minimum spring length, and is interposed between the undulating body and the crane body to support the undulating body from behind while applying forward bias force to the undulating body when the undulating body is in the rising state and the spring member is contracted from the maximum spring length, and
the restraining member is interposed between the crane body and the undulating body and receives the load of the undulating body to restrain the undulating body from falling backward when the undulating body is in the rising state and the backstop has the restrained length with the spring member is contracted to a length between the maximum spring length and the minimum spring length.

4. The crane according to claim 3, wherein
the restraining member is disposed to be interposed between the crane body and the undulating body at a position between the backstop and the undulating body fulcrum in a direction parallel to the rotation center axis.

5. The crane according to claim 3, wherein
the restraining member includes a restraining member proximal end portion supported on the undulating body and a restraining member distal end portion opposite to the restraining member proximal end portion, and is disposed to project from the undulating body,
the crane body includes a restraining member receiving portion configured to receive the restraining member distal end portion, and
the restraining member receives the load of the undulating body with the restraining member distal end portion being in contact with the restraining member receiving portion when the undulating body is in the rising state and the spring member has the restrained length.

6. The crane according to claim 5, wherein
the crane body includes
a slewing frame, and
a support frame disposed in a front end portion of the slewing frame and including an undulating body backing portion rotatably supporting the undulating body fulcrum, and
the restraining member receiving portion is disposed on the support frame.

7. The crane according to claim 5, the crane further comprising
a mast including a mast proximal end portion rotatably supported on the crane body at a position behind the undulating body, the mast supporting the undulating body from behind, wherein
the crane body includes a slewing frame,
the slewing frame includes a mast backing portion rotatably supporting the mast proximal end portion, and
the restraining member receiving portion is disposed on the mast backing portion.

8. The crane according to claim 5, wherein
the undulating body is dividable into a plurality of members, and includes at least an undulating body lower member including the undulating body fulcrum, and
the restraining member proximal end portion is supported on the undulating body lower member in a portion closer to the undulating body fulcrum than a longitudinal center portion of the undulating body lower member.

9. The crane according to claim 1, wherein
the crane body includes
a lower travelling body,
an upper slewing body disposed above the lower travelling body, and
a slew bearing disposed to be interposed between the lower travelling body and the upper slewing body, and configured to allow the upper slewing body to slew about a slew center axis extending in an up-down direction with respect to the lower travelling body,
the undulating body fulcrum of the undulating body is supported on the upper slewing body to be rotatable in the undulation direction,
the undulating body includes a backstop first backing portion disposed closer to a distal end than the undulating body fulcrum and supporting the first end portion of the backstop, and
the upper slewing body includes
an undulating body backing portion rotatably supporting the undulating body fulcrum about the rotation center axis extending horizontally, and
a backstop second backing portion disposed ahead of the slew center axis and behind the undulating body backing portion in a front-back direction of the upper slewing body, and supporting the second end portion of the backstop as the assistance structure.

10. The crane according to claim 9, wherein
the upper slewing body further includes a base body having a box shape and including the undulating body backing portion and the backstop second backing portion.

11. The crane according to claim 10, wherein
the base body has an upper surface, and
the backstop second backing portion is disposed on the upper surface.

12. The crane according to claim 11, wherein
the undulating body backing portion is disposed in a front end portion of the base body, and
the backstop second backing portion is disposed in a rear end portion of the base body.

13. The crane according to claim 11, wherein
the upper slewing body includes
a bottom plate supported to be slewable on the lower travelling body, and
a longitudinal plate standing to extend in a front-back direction on the bottom plate, and
the base body has a lower surface opposite to the upper surface and supported on the bottom plate, and a side surface connecting the upper surface and the lower surface and connected to the longitudinal plate.

14. The crane according to claim 9, wherein
the first end portion of the backstop is coupled to the backstop first backing portion to allow the backstop to rotate integrally with the undulating body relatively to the upper slewing body, and
when the undulating body rises from the upper slewing body, the second end portion of the backstop comes into contact with the backstop second backing portion to restrain further backward rotation of the undulating body.

15. The crane according to claim 14, wherein
the first end portion of the backstop is fixed to the backstop first backing portion to keep a posture of the backstop relative to the undulating body in a direction parallel to the rotation center axis.

16. The crane according to claim 15, wherein
the undulating body is dividable into a plurality of members, and includes at least an undulating body lower member including the undulating body fulcrum, and
the second end portion of the backstop is disposed ahead of a rear end portion of the undulating body lower member in a state where the undulating body rises from the upper slewing body to have a center line extending vertically.

17. The crane according to claim 9, wherein
the second end portion of the backstop is coupled to the backstop second backing portion to allow the undulating body to rotate relatively to the backstop and the upper slewing body, and
when the undulating body rises from the upper slewing body, the first end portion of the backstop comes into contact with the backstop first backing portion to restrain further backward rotation of the undulating body.

18. The crane according to claim 9, wherein
the undulating body is dividable into a plurality of members, and includes at least an undulating body lower member including the undulating body fulcrum, and
the backstop first backing portion is disposed on the undulating body lower member at a position closer to the undulating body fulcrum than a longitudinal center portion of the undulating body lower member.
